(19) United States
(12) Patent Application Publication
(10) Pub. No.: US 2006/0193316 A1
(43) Pub. Date: Aug. 31, 2006

(54) Autonomous network topology and method of operating same

(76) Inventor: Mark Russell Allen, Houston, TX (US)

Correspondence Address: Hugh R. Kress;Browning Bushman P.C., Suite 1800, 5718 Westheimer, Houston, TX, 77057, US

(21) Appl. No.: 11/067,141

(22) Filed: Feb. 25, 2005

(51) Int. Cl. H04L 12/56

(52) U.S. Cl. 370/389; 370/401

(57) ABSTRACT

An autonomous network topology for transient network devices. In a network comprising a plurality of autonomous, transient nodes, each node maintains a list of other nodes that are currently within its “line-of-sight,” i.e., other nodes with which a node can exchange packets of information directly. Each node also maintains a list of other nodes that are not currently within its line-of-sight, but whose identities are known to the node through processing of packets of information forwarded to that node from others. Each packet transmitted within the network contains information identifying the original sender of the packet and the sender's location at the time of dispatch, as well as information identifying the intended recipient of the packet and an estimate of the intended recipient's location. When a node receives a packet from a first other node and addressed to a second other node, the receiving node forwards the packet either to the intended recipient, if that node is on the receiving node's list of nodes currently within its line-of-sight, or otherwise to a second other node. The selection of such second other node is made based upon the estimate of the intended recipient's current location as compared with those nodes that are currently within the receiving node's line-of-sight. In some cases, a receiving node may revise the estimate of an intended recipient's location in a received packet, based upon the receiving node's list of nodes not currently within its line-of-sight.

### FIELD OF THE INVENTION

The present invention relates generally to the networking of two or more computers, and more particularly relates to the networking of computers whose physical locations may vary over time.

### BACKGROUND OF THE INVENTION

Internet Protocol (IP) is currently and by far the predominant technology used in networking devices together. Those of ordinary skill in the art will appreciate that IP is a network layer protocol in Open System Interconnection model (OSI). The so-called “network layer” of the protocol moves data packets between devices that do not have close physical connection in a Local Area Network (LAN). IP does this by assigning a unique number sub-range (sub-network) to each LAN, and network interconnections within a predetermined numeric range and devices on that LAN or Network Interconnection are assigned unique number (IP address) within the assigned range (sub-network). Devices that move data packets between these sub-networks are called “routers.” Two sub-network ranges that fall next to each other need not be located at the same physical location or under the control of the same organization.

With IP there is not a constant universal map that all routers can use to make the decision as to which router a data packet should be handed in order that it make it to its intended destination. To handle outages and define network topology, IP networks run various routing protocols between routers, keeping the routers updated with state information so that outages can be bypassed and the identity of sub-networks behind a router can be ascertained.

One possible drawback of the IP network topology is that it can be difficult to account for devices whose physical location is not static.

### SUMMARY OF THE INVENTION

In view of the foregoing, the present invention is directed to a network protocol and topology adapted to support networked communication between transient network devices.

As noted above, in accordance with one aspect of the invention, a network is established comprising a plurality of autonomous nodes whose physical location varies over time and can thus be characterized as “transient.” Further, the autonomous nodes are not bound together by a hierarchical structure. Instead, the present invention involves a method that works at the Open System Interconnection (OSI) “Network Layer” to create a novel network protocol referred to herein as an “Autonomous Network Topology” or “ANT.”

In accordance with one aspect of the invention, each node in the network is identified by a unique number and physical location, as may be analogized to latitude/longitude/altitude. Traffic (communications in the form of packets of information) from a given physical location is used as an indicator of a path to that physical location. To send traffic (packets), a node must be willing to relay traffic from other nodes. All nodes physically lie within a broadcast distance of another node, but not all nodes are within the same broadcast distance.

A node within the Autonomous Network Topology makes decisions based solely on information gained by network traffic passing through the node itself or through nodes within its reception range. By mathematically modeling the traffic passing through nodes within a node's reception range, an ANT node can forward traffic destined for locations not within its “line of sight” to a node that will have a higher probability of reaching the targeted node's physical location.

An ANT node monitors traffic passing within its broadcast range. An fundamental concept underlying the invention is that every data packet contains information identifying its starting physical location. Thus, a path can be inferred from a packet's current location back to its starting point. An ANT node will model the data flows of nodes within its line of sight (“LOS”) and determine the probability of a LOS node to reach a location that is not in that node's LOS. Factors such as the location of a LOS node, movement of an LOS node over time, the position of a LOS node in relation to a given ANT node over time, the starting locations of traffic being handled by an LOS node, whether traffic from a targeted Unique Numbered Node was handled by a LOS node, the rate of traffic being handled by a LOS node, and other information that can be inferred by the data being passed is used to model the probability of a LOS node reaching a location that is not in a given node's LOS. Each ANT node acts independently from others and nodes do not pass “routing” information between each other as is the case in prior art network topologies. An ANT node makes its “best guess” and routes will emerge from the independent behavior of each ANT node.

By a set of behaviors, a single ANT is able to route packets within the network for itself and for other ANT nodes.

### BRIEF DESCRIPTION OF THE DRAWINGS

The foregoing and other features and aspects of the subject invention will be best understood with reference to a detailed description of specific embodiments of the invention, which follow, when read in conjunction with the accompanying drawings, wherein:

FIG. 1 is a diagram showing two nodes in a network in accordance with the presently disclosed embodiment of the invention;

FIG. 2 is a diagram showing a node in the network of FIG. 1 without another node in its line-of-sight;

FIG. 3 is a diagram showing a plurality of nodes in a network in accordance with one embodiment of the invention and showing the relay path of a packet transmitted from a sending node to a receiving node;

FIG. 4 is a diagram showing the nodes from FIG. 3 where the receiving node's physical location has changed;

FIG. 5 is a diagram showing nodes in the network of the present invention showing the relay path of a packet transmitted from a sending node to a receiving node;

FIG. 6 is a diagram illustrating relative lines-of-sight of a plurality of nodes in the network of the present invention;

FIG. 7 is a diagram illustrating two clusters of nodes in the network of the present invention;

FIG. 8 is a diagram illustrating a distributed sensor array communicating with a plurality of servers using the autonomous network protocol in accordance with the present invention; and

FIG. 9 is a diagram illustrating a mechanism for reestablishing discontinued communications between two nodes in the network of the present invention.

### DETAILED DESCRIPTION OF A SPECIFIC EMBODIMENT OF THE INVENTION

The disclosure that follows, in the interest of clarity, does not describe all features of actual implementations. It will be appreciated that in the development of any such actual implementation, as in any such project, numerous engineering and clinical decisions must be made to achieve the developers' specific goals and subgoals, which may vary from one implementation to another. Moreover, attention will necessarily be paid to proper engineering and clinical practices for the environment in question. It will be appreciated that such a development effort might be complex and time-consuming, but would nevertheless be a routine undertaking for those of ordinary skill in the relevant fields.

The first behavior associated with the practice of the presently disclosed embodiment of the invention is referred to herein as “passive discovery.”

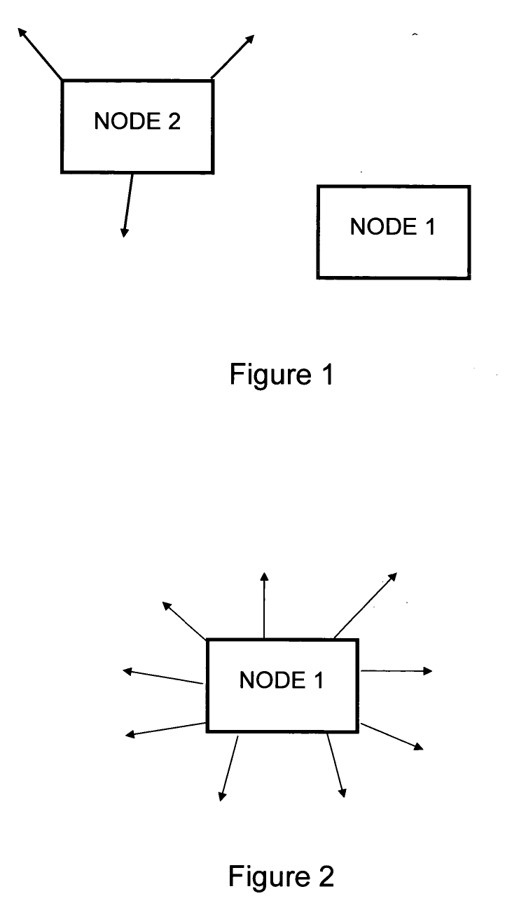

Referring to FIG. 1, there is shown a simplified “network” comprising two network devices or nodes, identified as “Node 1” and “Node 2.” Various network devices are well-known and commercially available, and those of ordinary skill in the art will appreciate that network devices can take many different forms, including, for example, laptop or notebook computers, handheld digital devices, cellular telephones and similar communications devices, and so on. A laptop computer, for example, may be equipped with a network adapter and a wireless transceiver permitting the device to participate in communications over a network with other similarly outfitted devices. The network adapter would include logic and control circuitry for causing the network device to operate in accordance with a predefined networking protocol, such as that described hereinbelow, as would be apparent to anyone of ordinary skill in the art.

It is believed that the particular details of implementation of a network device operable as a node in an autonomous network topology as shall be described herein are not necessary for the purposes of appreciating the present invention, and that implementation of particular embodiments of the invention, including network control logic and circuitry for causing a network device to operate in accordance with the protocol disclosed herein, would be a matter of routine engineering to persons of ordinary skill in the art.

In illustrative example of FIG. 1, Node 1 “hears” traffic (represented as arrows in FIG. 1) created by Node 2. In the presently disclosed embodiment of the invention, communications “traffic” can take many forms, including but not limited to wireless network communications, such as defined according to the well-known IEEE 802.11 standard, commonly known as “WiFi.” Each arrow in FIG. 1 (and in subsequent Figures) represents a “packet” of data (an “ANT packet”) transmitted by a node.

From the traffic generated by Node 2 in FIG. 1, Node 1 would add Node 2 to its table of “LOS” gateways, i.e., to Node 1's listing of nodes which are in its “line-of-sight.” (It is to be understood for the purposes of the present disclosure that the term “line-of-sight” is intended to be interpreted figuratively, not literally, and shall apply to any situation in which one node among a plurality of nodes is capable of receiving communications packets from another node. That is, physical observability of one node by another is not necessarily required in order for the nodes to be in each other's “line-of-sight.”)

In accordance with one aspect of the invention, each ANT packet contains, at a minimum, the following information “From ID-Location,” “To ID-Location” and “Relay ID-Location.”

Turning to FIG. 2, it is possible for an ANT node to be physically located such that no other nodes are present in its LOS. In such cases, a node such as Node 1 in FIG. 2 would send an “Offer to Relay” all points gateway packet.

This “Offer to Relay” all points packet preferably contains special identification information and would be short lived (i.e., cannot be relayed). The “Offer to Relay” function bridges both OSI “Data Link” layer and OSI “Network” layer (IP “ARP” like protocols could provide the “data link” layer for ANT).

Nodes that receive an “Offer to Relay” packet would add the node which generates it to their LOS gateway table. In addition, the receiving node could generate its own “Offer to Relay” packet if it has not sent traffic for a period of time. The purpose of this behavior is to create traffic only during periods of time that have low packets rates and suppress this behavior during high traffic times.

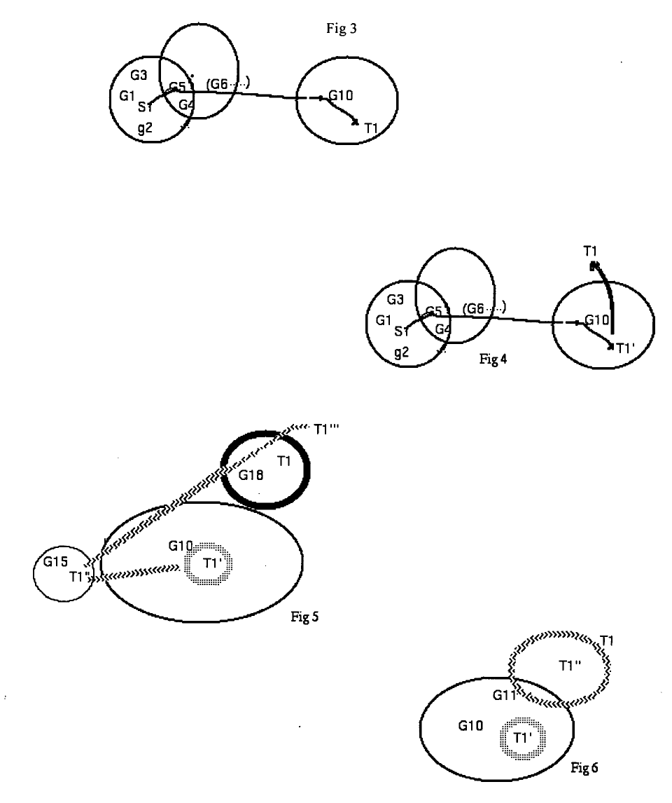

With the “discovery behavior” and each node's LOS gateway table, the routing of data packets through the ANT network is almost complete. FIG. 3 illustrates an example. In FIG. 3, a plurality of nodes S1, T1, G1, G2, . . . are shown. The circles in FIG. 3 identify which nodes are within the others' respective lines of sight. For example, as shown in FIG. 3, Nodes G1, G2, G3, G4, and G5 are within Node S1's LOS (and hence are represented by entries in Node S1's LOS table), while Node G6, G10, and T1 are not in Node S1's LOS.

Node S1, present at a first physical location in FIG. 3 is shown to be sending traffic intended to be directed to Node T1 present at a second physical location. Using the location part of T1's identification from a previous communication, Node S1 determines that T1's last known physical location places Node T1's direction 055 degrees (a hypothetical example, of course) from true north from Node S1's location. Based on this assessment, Node S1 selects Node G5, which is in Node S1's LOS, to be the immediate recipient of its ANT packet. Node G5 uses its data and the same method to select Node G6 to which to “hand off” Node S1's packet.

This “hand off” process continues until the packet reaches Node G10. Node G10 has Node T1's unique number in its LOS table and sends the packet directly to Node T1.

Those of ordinary skill will appreciate that the foregoing example with reference to FIG. 3 describes the path for only a single packet transmitted from Node S1. At a later time Node S1 might select Node G4 to which to hand off the packet intended for Node T1, even if all other factors remain the same. A level of chaos (randomness) will send some packets on disfavored paths (i.e., paths that are less than optimal in terms of path length and number of hand-offs), but it this advantageously also leads to the discovery of new paths, thereby enhancing the robustness of the ANT system.

In accordance with an important aspect of the invention, the location of each ANT node may move over time. The issue arises that the targeted node location might have moved a great distance.

Referring to FIG. 4, there is shown a scenario in which Node T1 has moved from its original location (represented by T1′ in FIG. 4) to a new location, represented by T1 in FIG. 4. Since Node T1 is not in Node S1's line-of-sight at either its original location or its new location, Node S1's information about Node T1's location is “stale.” This problem is addressed by the present invention through behavior referred to herein as “Fuzzy Location Tainting”

Referring to FIG. 5, “Fuzzy Location Tainting” occurs when a packet bound for T1′ reaches node G10, but the original location for T1 has moved. Node G10 can receive packets from nodes within the R1 radius. When the ratio between R1 and the distance from G10 to T1′ (radius R0) exceeds a reasonable value, a new random location T1″ will be selected and will be bounded within a probability circle P1 centered at T1′ with a distance from T1′ to T1″ being greater than R1. The packet's destination location will be changed by G10 and the packet marked in some fashion to indicate that it has been modified by the “Fuzzy Location Tainting” process. As illustrated, G10 sends the packet to assumed location T1″. G15 makes the same change as G10 but increases the probability circle to P1′ when selecting T1′″ as an assumed location for Node T1. While the packet is in transit to T1′″, it passes though G18, which has actual knowledge (as opposed to randomly selected or assumed information) as to the location of Node T1. G18 removes the taint and directs the packet to Node T1's current location. Once a packet's location is tainted, the packet will bounce within larger domains centered around its original target location until either its target is located or the packet is dropped.

As will be appreciated by those of ordinary skill in the art, the forwarding of packets using Fuzzy Location cannot be boundless. In all cases, a node can silently drop packets for whatever reason the node wishes. Some but not all the reasons an ANT node would dropped packets include, in the presently preferred embodiment of the invention, a node being overloaded with packets to forward, a node experiencing irregularities concerning a particular targeted location, the Fuzzy Location probability circle being unreasonably large, corrupted packets, or packets that are too old.

An additional behavior called “Around the Corner” can be used to improve the possibility that a packet will reach its destination. In this scenario illustrated in FIG. 6, assume that G10 has a strong indicator to pass traffic to Node T1 then Node T1 moves out of Node G10's LOS. Node G10 cannot directly know the current location for T1 when G10 lost LOS of T1 but it can assign a “best guess” location T1″. Based on the probable location T1″, G10 selects G11 with the hope that G11 has knowledge of T1 or is also a strong indicator for the same destinations as T1. These “best guess” assignments of a node location in a special LOS table is called “Shadow LOS”. When a gateway node moves out of LOS, an ANT node moves the data into a shadow LOS. This allows for indirect reference to paths through nodes that recently move out of LOS. An additional benefit is that nodes that are on the edge of LOS can move back and forth between LOS and “Shadow LOS” and reduce the overhead with re-learning the information about a node. The “Shadow LOS” table will be aged to expire nodes that have moved well out of range.

In accordance with another aspect of the invention, there is a further table of information that all ANT nodes must maintain. In particular, in the process of modeling the traffic passing within its broadcast range, a node will gain knowledge of “From ID-location” packets passing through or near its location. The node will maintain an “Out of Site (OOS)” table of frequent “From ID-locations.” The “OOS” is useful, when relaying, to change the “location” part in the “To ID-location” for a packet to more probable location for an ID. The “From” data streams from a node will “bend” traffic destined for itself by the action of the “OOS” tables in node relaying packets on its behalf.

Those of ordinary skill in the art will appreciate that a major issue in many networks and network protocols is routing loop suppression. An ANT network in accordance with the presently disclosed embodiment of the invention has behaviors that tend to passively suppress some loops.

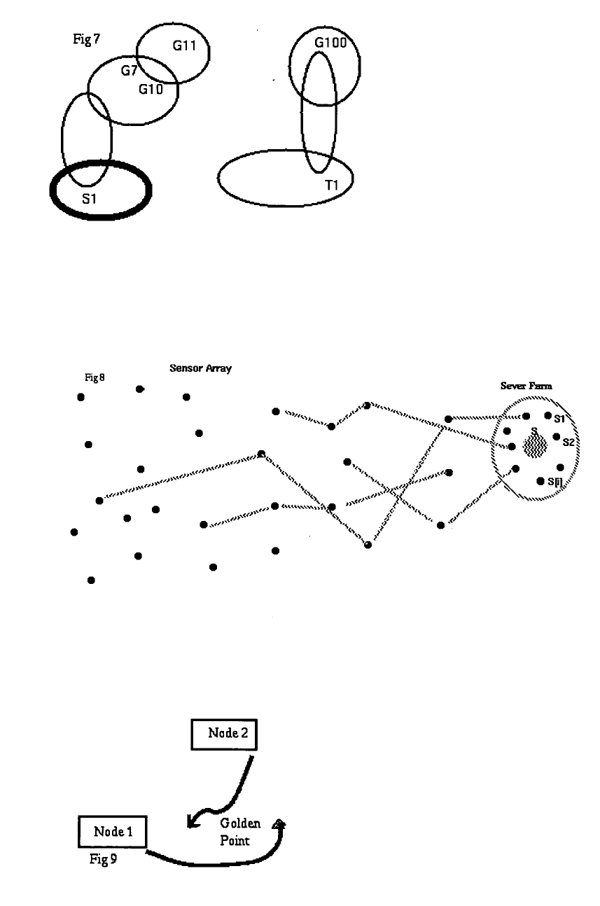

Referring to FIG. 7, a scenario is depicted in which Node S1 is sending a packet to Node T1. Note that clusters that contain Nodes S1 and T1 are isolated from each other. Assume that the packet from Node S1 to Node T1 makes its way around the region of the nodes G10, G7, and G11. If the packet loops between Nodes G10, G7, and G11, the loop will break because one of the nodes preferably applies one or more metrics to decide eventually to drop the packet. Such metrics could include the aforementioned “Traffic rate to high” determination, or other determinations such as that the packet has been handed off to the same node(s) repeatedly without appearing to have reached its destination. It is contemplated that other behaviors and decision making metrics will similarly tend to suppress loops

In accordance with one aspect of the invention, it is contemplated that there could be nodes that do not meet all the qualifications for an ANT node. One such limited node is referred to as a “Terminus Transport Endpoint (TERMITE) Node.” A TERMITE node would break the “willing to relay” and “identification by unique number and location” rules. A TERMITE node would not provide its location. An ANT node that has a TERMITE node within its LOS will tag all packets relayed on behalf of the TERMITE nodes with its own location and will not maintain location information for the TERMITE node (without location information, only direct LOS commutation is possible, making it unavailable for outbound relaying). ANT nodes also cannot maintain “Shadow LOS,” or “Around the Corner” behavior for TERMITE nodes. TERMITE nodes themselves could maintain simplified LOS tables and not try to model traffic in high detail. TERMITE nodes are ANT “light” nodes but with corresponding limited functionality.

In accordance with one aspect of the invention, application load balancing is straightforward. Assume, for example, a system involving a massive sensor array 50 comprising a plurality of sensors, with each element moving independently of the others, as depicted in FIG. 8. Assume further the following characterizations:

(1) Each sensor (represented by black dots in FIG. 8) in sensor array 50 knows its current physical position.

(2) Each sensor is equipped with a communications transceiver.

(3) Not all sensors are in range of a server farm (designated with reference numeral 52 in FIG. 8).

(4) Not all sensors are in range of all of the others, but are in range of at least one other sensor or server node in server farm 52.

(5) The data from any sensor can be accepted by any node (S1, S2, etc . . . ) in the server farm 52.

Under these assumed conditions, each sensor node is creating or forwarding traffic to the server farm 52. The total amount of traffic flowing to the server farm can exceed the capacity of a single server. As shown, the sensors send to a virtual sever S. The set of servers (S1 . . . S[I]) near to the virtual location for S answers to the “S” identity. There is fluidity in identity within an ANT network. This fluidity gives rise to several special features such as all gateways to other network types could have the same reserved “unique ID” or the aggregation of large cluster of servers into a single virtual server.

With the system of the present invention, nodes that might be characterized as “ships that pass in the night” can find each other. The use of virtual server at a virtual location can be expanded. If the precision of the location greatly exceeds the broadcast ranges (for example, range in miles, position in feet) then special locations can be reserved from being used by real nodes these points are here in referred as “Golden Points”. Use of these special locations can give rise to “rendezvous” between two nodes, as follows: A node at one physical location is in conversation with a node at another physically remote location. These nodes could agree at the start of the conversation on a “Golden Point” location to be used to reestablish communication, if the two nodes lose each other (i.e., their packets begin to not be delivered back and forth properly), then each node would send packets to the agreed upon a “Golden Point”. If their packets reach the Golden Point (affecting “OOS” tables maintained by nodes near the Golden Point), they will establish a path from the golden point back to their location and thus reestablish communication.

A variation of this is a node that is looking for a service. The node would send a packet with a “To” address of a “special unique number” that would define the service as part of the identification and a Golden Node as the location. The server offering to provide the service would send a packet with the “special unique number” and its location as the “From” identification and the “target node” the golden point. The server seeds the path from the Golden Points to itself (affecting “OOS” tables). The packet from a node looking for the service will reach the golden point and jump onto the path to the server. The “fuzzy location,” “around the corner,” and other behaviors will speed the packet from the “virtual” location at the Golden Point to a real location. By removing less than one percent of all locations, from use by real physical machines, several possibilities arise in session and resource management.

Also there can be a “bread crumb trail” that an ANT node can create when it moves about. The node would send packet to its former location and established a path from its old location to its current location.

Consider a possible session. Someone named “Bill” is physically located at a first location and turns on an ANT node. Within seconds, it would see a hundred or so ANT nodes within its LOS. Bill wants to make an OSI application level connection with his friend Jack's node. Bill's application first needs to locate Jack's node. Bill sends a request to a “Name Directory” server at a “golden point.” On the way to or near the “golden point”, the request is redirected from the “golden point” to a real location that a server has seeded within the area. The “Name Directory” server replies to Bill's node with a possible location for Jack's node. The application on Bill's node now starts to open a connection to Jack's node by sending a packet to Jack's location as provided by the “Name Directory” server. Bill's packets transverse the network until they reach Jack's assumed location but Jack's node has moved. Jack's node has been a good node in that it has been performing “bread crumb trail” activities and there is an established path from Jack's old location to his current location. Because of this established path, Bill's packet will be directed to Jack's node current location. When Jack's node replies, it will use the location provided in the packets sent by Bill's node and bypass the need for a “Name Directory” server. The replies from Jack's node would reach Bill's node and would update Bill's node with Jack's node new location. With basic connectivity completed, Bill's and Jack's nodes complete the handshaking for the application.

It is contemplated that the autonomous network topology and protocol in accordance with the presently disclosed embodiment of the invention may be readily integrated with current networking standards.

The ANT Network protocol works at the OSI “Network Layer.” For the total network solution the OSI “Transport Layer” and above could use the well-known “Transmission Control Protocol” (TCP). The full OSI stack could be expressed as TCP/ANT. The “Internet Protocol” (IP) would be replaced by the “Autonomous Network Topology.”

Those of ordinary skill in the art having the benefit of the present disclosure will recognize that several features of the new Internet Protocol (IPv6) can be used in ANT networking for inter-operating with the TCP layers. In IPv6, addresses are a 128 bits and IPv6 has methods to add header extensions. ANT information can be embedded within an IPv6-like packet as a header extension. The “unique number” that is required for ANT node identification could be an IPv6 address. By making the ANT network packets “IPv6-like,” the higher layer applications could be tricked into performing as though they are sitting within an IPv6 network.

In one embodiment, it is contemplated that gateways between ANT and IP networks can use the “TERMITE” node structures described hereinabove. The ANT network maps the IPv6 devices as TERMITE nodes behind ANT node gateways. The IPv6 networks would see the gateway as a router to another IPv6 network. There is a good possibility of nearly seamless traffic between these network types with the right choices on the ANT packet structure.

Use of ANT networking on non-broadcast or switch media (like switch Ethernet) is possible. The OSI layer two approaches used in OSPF V2 for non-broadcast networks shows that solutions can be created. The nature of most non-broadcast networks does not have the devices in constant movement and some inflexibility can be afforded in any solution.

The present invention may be better understood by way of the following two analogies: First, imagine a endless flat plain. There are cars being driven around on this plain without any apparent order. Passengers are leaping from car to car, and when each one does, he shouts out the location-identification of the car he is leaving, location-identification of his origination, and the location-identification of his destination.

Consider a particular driver driving one of these cars. Some cars are close enough for the driver to hear their passengers as they leap and other cars are too far way. For those cars that are close, the driver starts to keep track of what the leaping passengers are saying (information like where the car is located, its Identification, and the passenger origination location-identification).

Now the driver wants to send a message to another car (the driver knows its location and identification). First the driver creates a passenger, and tells him the driver's car's current location and identification. The driver checks the information that he has been keeping on other cars that are within listening distance. If the desired destination car is within that table, then the driver will tell the passenger the destination car's current location and have the passenger leap directly to that car. When the destination car is not within that distance, the driver then uses the tables of the close cars to make a “best guess”. Factors like “Am I seeing traffic from the destination car identification?”, “Is a car close handling lots of traffic from the general direction or location of the destination location?”, or “Is a car in the right direction?” will be considered in making the “best guess.”

Once a next car is determined, the driver tells the passenger the destination location-identification and have the passenger leap to that next car.

Of course, unexpected passengers will be leaping into the driver's car. The driver has several choices. The driver can just ignore them. The driver also can handle unexpected passengers as if he was his own passenger, with the exception that the driver cannot change his origination location-identification or destination identification.

With this strange game of leap frog, passengers should on average reach their destination. The cars in this analogy are the Autonomous Network devices (nodes). Passengers are data packets being passed between devices. With each device relaying packets in the same manor, the overall effect is a network that spans both devices close to each other and also those that are great distances apart.

Another view is the following analogy: A person is standing on the banks of the Nile river in Egypt. The person takes a fish. The person writes his location and name on one side of the fish. On the other side the person writes the name and location of the destination he wants the fish to contact, then the person drops this fish in the river. In this hypothetical case, the destination is “Jack at 5001 Main Street, Galveston, Tex. USA”. Now, this is a smart fish and it can read the starting location written on this side of the other fishes. The fish notes that other fish coming from upstream only have starting locations inside Africa while those coming from downstream have starting locations from around the world including the USA. The fish decides to swim downstream (the analog of “best guess”). The fish will reach the Mediterranean Sea and the general flow of other fish from the USA will influence the fish to swim eastward towards the “Straits of Gibraltar”. Once in the Atlantic the fish will generally swim east until it encounters the “Gulf Stream Current”. Within the “Gulf Stream” there is a torrent of fish swimming from Galveston and other Gulf of Mexico ports to various UK and Northern Europe ports. This stream will cause the fish to swim in this channel backtracking the fish that it sees coming from Galveston. As the fish gets closer to Galveston, it is possible that it will see fish with a starting name of “Jack”. In this hypothetical world of our fishes, there is only one person named “Jack.” If the fish sees another fish with a starting location of “Jack at 5100 Main Street, Galveston, Tex. USA” it will erase the old location for “Jack” on its side and replaced it with the new location. Thus the fish swims closer and closer to “Jack” until it jumps into Jack's Lap and disgorges its information.

In this analogy, the fish is the data packet and the streams and oceans are the intra-connections between the ANT nodes. The analogy shows how the small scale behaviors of the independent ANT node can create a large scale behavior of network routing.

In conclusion, several aspects make an “Autonomous Network Topology” style network interesting. Given the lack of a “Top Down” topology and the independent nature of the nodes, a network in accordance with the present invention is highly scalable. These properties also speed deployment, in that there is not a centrally controlled design. “Autonomous Network Topology” networks are very resilient to outages and it is possible that stability increases in “Autonomous Network Topology” networks as node density increases (greater possibilities of multiple paths). “Autonomous Network Topology” type networks can solve several real world problems in networking.

From the foregoing, it will be apparent to those of ordinary skill in the art that a method and apparatus for networking computer devices has been disclosed which facilitates networked communication between dynamically located devices. Although a specific embodiment of the invention has been disclosed, it is to be understood that this has been done solely for the purposes of describing various aspects of the invention, and is not intended to be limiting with respect to the scope of the invention as defined by the claims that follow. It is contemplated that various substitutions, alterations, and/or modifications, including but not limited to those design alternatives specifically mentioned herein, may be made to the disclosed embodiments without departing from the spirit and scope of the invention as defined in the claims.

What is claimed is:

1. A method of operating a network comprising a plurality of transient, uniquely-identifiable nodes between which packets of information are exchanged, comprising:
(a) maintaining at each node a list of other nodes within said each node's line-of-sight;
(b) maintaining at each node a list of other nodes that are not in said each node's line-of-sight but whose packets of information have been passed to said each node.

2. A method in accordance with claim 1, further comprising:
(c) receiving, at a first node, a packet of information sent from a second node and addressed to a third node, said packet of information including an identification of said second node and its location at the time said packet was sent and an identification of said third node and an estimate of said location of said third node;
(d) forwarding said packet of information from said first node to a fourth node, where said fourth node is selected by said first node based upon said estimate of said location of said third node.

3. A method in accordance with claim 2, further comprising:
(e) prior to said step (d) of forwarding said packet of information to said fourth node, revising said estimate of said location of said third node.

4. A method in accordance with claim 1, further comprising:
(c) from each node, periodically broadcasting a packet of information expressing said each node's readiness to receive a packet from another node, said packet of information including an identification of said each node and its current location.

5. A method in accordance with claim 1, further comprising:
(c) receiving, at a first node, a packet of information sent from a second node and addressed to a third node, said packet of information including an identification of said second node and its location at the time said packet was sent and an identification of said third node and an estimate of said location of said third node;
(d) applying predetermined criteria to information contained in said packet to determine whether said packet should or should not be forwarded to another node.

6. A network comprising
a plurality of transient, uniquely-identifiable nodes between which packets of information are exchanged;
wherein each node maintains a list of other nodes within said each node's line-of-sight;
and wherein each node maintains a list of other nodes that are not in said each node's line-of-sight but whose packets of information have been passed to said each node.

7. A network in accordance with claim 6, wherein each node includes a transceiver for receiving packets of information sent from other nodes and for sending packets of information to other nodes.

8. A network in accordance with claim 7, wherein each packet of information transmitted from a sending node includes information identifying the said sending node and said sending node's current location and information identifying an intended recipient of said each packet and an estimate of said intended recipient's current location.

9. A network in accordance with claim 8, wherein each node's transceiver is adapted to receive a packet transmitted from a first node and to forward said packet of information to a second node, where said second node is selected by said each node based upon said estimate of said location of said intended recipient.

10. A network in accordance with claim 9, wherein said each node's transceiver is adapted to selectively revise said estimate of said location of said intended recipient based on information contained in said each node's list of nodes within its line-of-sight and in said each node's list of nodes not within its line-of-sight.

11. A network in accordance with claim 6, wherein said each node's transceiver is adapted to periodically broadcast a packet of information expressing said each node's readiness to receive a packet from another node, said packet of information including an identification of said each node and its current location.

12. A network in accordance with claim 6, wherein upon receipt of a packet from another node, each node is adapted to apply predetermined criteria to information contained in said packet to determine whether said packet should or should not be forwarded to another node.

13. A network device, comprising:
a transceiver for sending packets of information to other network devices and for receiving packets of information from other network devices, each of said packets of information including an identification of the sender of said packet and said sender's location, and an identification of an intended recipient of said packet and an estimate of said intended recipient's physical location;
network control circuitry for processing packets of information received by said transceiver and for generating packets of information to be sent by said transceiver;
wherein said network control circuitry further operates to maintain a listing of other network devices currently in said network device's line-of site and a listing of other network devices not currently in said network device's line-of-site;
and wherein said network control circuitry identifies other network devices not currently in said network device's line of sight based upon identifications of senders contained in packets of information received by said transceiver.

14. A network device in accordance with claim 13, wherein said network control circuitry is responsive to receipt of a packet of information from a first other network device to cause said transceiver to forward said packet of information to a second other network device, said second other network device being selected by said network control circuitry based on said identification of said intended recipient and said estimate of said intended recipient's location contained in said received packet.

15. A network device in accordance with claim 14, wherein said network control circuitry is responsive to receipt of a packet of information to selectively revise said estimate of said intended recipient's location based upon information in said list of network devices in said network device's line-of-sight and on said list of network devices not in said network device's line-of-sight.
